(19) United States
(12) Patent Application Publication
(10) Pub. No.: US 2023/0140227 A1
(43) Pub. Date: May 4, 2023

(54) SYSTEMS AND METHODS FOR REFINING SPIRITS

(71) Applicant: BESPOKEN SPIRITS, INC., Menlo Park, CA (US)

(72) Inventors: Martin JANOUSEK, Mountain View, CA (US); Jordan SPITZER, San Mateo, CA (US); Arne BALLANTINE, Palo Alto, CA (US); Sanjiv KAPOOR, San Jose, CA (US)

(21) Appl. No.: 17/905,548

(22) PCT Filed: Mar. 4, 2021
(86) PCT No.: PCT/US21/20878

§ 371 Date: Sep. 2, 2022

Related U.S. Application Data
(60) Provisional application No. 62/985,657, filed on Mar. 5, 2020.

(51) Int. Cl. C12G 3/07; C12H 1/22

(52) U.S. Cl. CPC C12G 3/07; C12H 1/22

(57) ABSTRACT

Systems, methods, and devices of the various embodiments may enable the maturing of spirits or other products. Various embodiments may provide methods for creating matured spirits from raw spirits in which the process steps are performed on a batch of spirits material. Various embodiments may include applying process controls, such as feed-forward controls, to achieve one or more desired parameters of the matured spirits. Various embodiments may include a spirits processor configured to create matured spirits from raw spirits.

### RELATED APPLICATIONS

This application claims the benefit of priority to U.S. Provisional Application No. 62/985,657 entitled “System and Methods for Refining Spirits” filed on Mar. 5, 2020, the entire contents of which are hereby incorporated by reference for all purposes.

### BACKGROUND

Standard processes for maturing spirits or other products typically involve the distilled spirits or other products being placed into a barrel, such as an oak: barrel, and kept in contact with the inner surface of that barrel for a period of time. In these standard processes, the barrel itself may be treated, such as by charring, in an to attempt to deliver a desired flavor to the spirits or other products. However, these standard processes have not allowed accurate forecasting of the flavor results of the maturing process. Feed-forward processes where spirit or other product flavors are directed toward desired results are needed.

### SUMMARY

Systems, methods, and devices of the various embodiments may enable maturing of spirits and other products. Various embodiments may provide methods for creating matured spirits from raw spirits in which the process steps are performed on a batch of spirits material. Various embodiments may include applying process controls, such as feed-forward controls, to achieve one or more desired parameters of the matured spirits. Various embodiments may include a spirits processor configured to create matured spirits from raw spirits.

Various embodiments may provide methods for creating matured spirits from raw spirits in which the process steps are performed on a batch of spirits material. Such methods may include the steps of creating micro-staves from a desired wood material, such as a hardwood, etc., inspecting the stave or micro-staves for a desired wood characteristic, toasting all or a portion of the stave or micro-staves having a desired wood characteristic, charring all or a portion of the stave or micro-staves having a desired wood characteristic, and introducing micro-staves having a desired wood characteristic, the charred micro-staves, and/or the toasted micro-staves into a processing device along with raw spirits, air, oxygen, and/or other mixtures and maintaining the conditions in the processing device for a period of 1 hour to several days to create a matured spirit.

Various embodiments may include methods wherein the ratio of untoasted, toasted, and charred micro-staves can be tailored to achieve a discrete repeatable flavor profile. Various embodiments may include methods wherein toasting temperature and time for micro-staves can be tailored to achieve a discrete repeatable flavor profile. Various embodiments may include methods wherein toasting temperature and time for micro-staves, as well as the ratio of untoasted, toasted, and charred micro-staves, can be tailored to achieve a discrete repeatable flavor profile. Various embodiments may include methods wherein controlling the charred surface area of micro-staves can be tailored to achieve a discrete repeatable flavor profile. Various embodiments may include methods using characterized metrics to monitor either design experiments or production processes and by forming correlations with taste factors eliminate the human taster from the evaluation process; and further allow for process control with the metrics of concern. Various embodiments may include methods of characterizing spirits using metrics which correlate to taste factors. In various embodiments, a transfer function of these spirits may be characterized as to their taste characteristics, and then a desired maturation process may be applied. In various embodiments, metrics which may be used in the characterizations and controls may include one or more of: pH of the spirits; color measurement of the spirits as measured with a spectrometer; gas chromatograph mass spectrometry to characterize the spirits for presence of key, compounds; the ultraviolet (LV) spectrum adsorption of the spirits; the turbidity measurement of the spirits; dissolved nitrate, nitrite, sulfate, sulfite, phosphate, phosphite concentration; measurement of specific acids; measurement of methanol or acetone; conductivity or resistivity measurements; and/or measurement of proof or water content.

Various embodiments may provide structures and methods for refining of spirits. Various embodiments may provide methods of spirits flavor and taste optimization through feed-forward of refining process parameters to achieve a desired end taste.

### BRIEF DESCRIPTION OF THE DRAWINGS

The accompanying drawings, which are incorporated herein and constitute part of this specification, illustrate example aspects of the claims, and together with the general description given above and the detailed description given below, serve to explain the features of the claims.

FIG. 1 illustrates a processing container where the various embodiment processes may be carried out.

FIG. 2 is a model of an embodiment of a refiner where the various embodiment processes may be carried out.

FIG. 3 illustrates an embodiment in-line process and device for maturing spirits.

FIG. 4 illustrates a system including a spirits processor according to various embodiments.

FIG. 5 illustrates a method for modifying the taste of input spirits based on a transfer function in accordance with various embodiments.

FIG. 6 illustrates example aroma prediction profiles according to various embodiments.

FIG. 7 illustrates example color prediction profiles according to various embodiments.

FIG. 8 illustrates a method for creating matured spirits from raw spirits in accordance with various embodiments

FIG. 9 illustrates an example computing device suitable for se with the various embodiments.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments relate to the process of maturing spirits or other products wherein the distilled spirits or other products are placed into a container, such as an oak barrel, and kept in contact with the inner surface of that barrel for a period of time. In the standard process, the barrel may be treated with a process such as charring to deliver desired flavors to the product.

Some methods attempt to accelerate the maturing of sprits through various means. In one method, heating in the presence of light is used; in another method, ultrasonic energy is introduced. Methods of heating, steam injection or application of pressure may also be used. None of these methods have been shown to consistently, accelerate the maturation process such that a controlled result may be achieved. These methods have not allowed accurate forecasting of the flavor results of the maturing process. Therefore, feed-forward processes where spirit flavors are directed toward desired results have not been practiced.

As used herein the term “matured” may refer to spirits that have been transitioned from raw (or unrefined) spirits toward a state having one or more selected profile characteristics, such as aroma, color, flavor, etc. Such transition may be referred to as “maturation” or “maturing”. Typically, such maturation of spirits has been achieved by typical barrel-based aging processes. Matured spirits may also sometimes be referred to as “aged spirits.” As discussed herein, a matured spirit (or maturation or maturing) may be achieved in different time frames, and the term matured (or maturation or maturing) as used in reference to the various embodiments is not intended to imply any specific time period and is not intended to limit the various embodiments or claims to any specific time period.

Various embodiments provide methods of creating matured spirits from raw spirits in which the process steps are performed on a batch of spirits material. In some embodiments, micro-staves may be created from the desired wood material, such as a hardwood (e.g., oak, ash, beech, etc.), softwood (e.g., cedar, juniper, pine, spruce, etc.), wood-like grass (e.g., bamboo, etc.), etc. In some embodiments, micro-staves may be inspected for desired wood characteristics. In some embodiments, micro-staves may be toasted. In some embodiments, micro-staves may be charred. In some embodiments, micro-staves may be toasted and charred. In some embodiments, micro-staves and spirits and air, oxygen, mixtures may be introduced into a processor and kept in those conditions for a period, such as a period of about 1 hour, a period of about 1 hours to a day, a period of 1 hours to several days, a period of several days, etc.

As used herein, the term “micro-stave” may refer to a smaller piece of wood rendered (e.g., cut, chopped, chiseled, etc.) from a larger piece of wood such that resulting smaller piece of wood (i.e., the micro-stave) has cubic dimensions of equal to or less than approximately 20 mm×20 mm×100 cm, but greater than approximately 0.09 mm×09 mm×0.09 mm Said another way, a micro-stave may be a processed (e.g., e.g., cut, chopped, chiseled, etc.) wood structure that completely fits within a rectangular volume that is 20 min×20 min×100 cm while not completely fitting within a rectangular volume that is 0.05 mm×0.05 mm×0.05 mm. Micros-staves may be rendered (e.g., cut, chopped, chiseled, etc.) from a larger piece of wood such that the volume and surface area of the wood piece that is the micro-stave is controlled to achieve a selected volume and surface area thereby enabling controlled and uniform extraction of the wood components by a spirit. While referred to herein using the term “micro” as part of “micro-stave” the term “micro” is not used in its metric system prefix meaning as part of “micro-stave” but is rather a descriptor indicating that the “micro-staves” as described herein are smaller than staves used in typical wine or spirit barrels which are often on the order of 10 mm×60 min×1000 mm or larger.

As used herein, the term “toasted” refers to a state of a wood product, such as a micro-stave, in which the wood product has been exposed to heat thereby causing thermal decomposition of the cellulose, hemicellulose and lignin in the wood forming the wood product without any resulting visible char accumulation on the external surface of the wood. Toasted wood products may have been heated such that some decomposition of the wood surface occurred without combustion reactions at the surface of the wood occurring to result in visible carbon residues (e.g., char layers). Toasting as described herein may be performed such that the entire volume of the wood is transformed and decomposed uniformly. Toasting may be done in an oven and may take a time period from minutes to hours or days to achieve a toasted state of a wood product.

As used herein, the term “charred” refers to a state of a wood product, such as a micro-stave, in which the wood product has been exposed to heat thereby causing thermal decomposition of the cellulose, hemicellulose and lignin in the wood to at least a point where visible char accumulates on the external surface of the wood. Charred wood products may have been heated such that some combustion reactions occurred at the surface of the wood resulting in visible carbon residues (e.g., char layers). Such resulting visible carbon residues (e.g., char layers) may be as thin as only a few microns (e.g., 2 microns) thick on the surface of the charred wood product. At least on surface of a wood product need not show visible carbon residues (e.g., charring) for the wood product to be considered a charred wood product, such that as long as a portion of the surface of the wood product is shows visible carbon residues (e.g., charring) the wood product is a charred wood product. In contrast, a toasted wood product may show no visible carbon residues (e.g., charring). Charring as described herein may be performed such that there is a gradient in wood transformation and decomposition due to very high temperatures at the surface that is being charred. Charring may be done with a heat source, such as a gas flame/torch, IR heater, etc., and may take a period of time from seconds to minutes to achieve a charred state of a wood product.

Various embodiments may provide methods for creating matured spirits from raw spirits in which the process steps are performed on a batch of spirits material. Such methods may include the steps of creating micro-staves from a desired wood material, such as a hardwood (e.g., oak, ash, beech, etc.), softwood (e.g. cedar, juniper, pine, spruce, etc.), wood-like grass (e.g., bamboo, etc.), etc., inspecting the wood material or micro-staves for a desired wood characteristic, toasting all or a portion of the wood material having a desired wood characteristic, charring all or a portion of the micro-staves having a desired wood characteristic, and introducing un-toasted micro-staves having a desired wood characteristic, the charred micro-staves, and/or the toasted micro-staves into a processing device along with raw spirits, air, oxygen, and/or other mixtures and the conditions in the processing device are maintained for a period of 1 hour to several days to create an matured spirit. In some embodiments, the wood material may be formed into micro-staves after inspection and/or toasting. In some embodiments, in addition to the untoasted micro-staves, toasted micro-staves, and/or charred micro-staves, other wood products may be added into the processing device, such as un-toasted wood material, wood powder (e.g., saw dust), etc. In some embodiments, other wood products, such as un-toasted wood material, wood powder (e.g., saw dust), etc., may be substituted for the untoasted micro-staves.

In various embodiments, micro-staves may be un-toasted. Un-toasted micro-staves may be formed from wood that is seasoned (e.g., left to dry for a specific time, such as 6-48 months). Un-toasted micro-staves may not be toasted or charred. In various embodiments, micro-staves may be toasted. Toasted micro-staves may be formed from wood that is toasted prior to forming the micro-staves. The wood may be seasoned or un-seasoned. In various embodiments, micro-staves may be charred. Charred micro-staves may be formed by charring toasted micro-staves and/or by charring un-toasted micro-staves.

Various embodiments include the method of creating matured spirits from raw spirits in which the following process steps are performed on a batch of spirits material;
a) Micro-staves are created from the desired wood material, such as oak, with dimensions of approximately 5-20 mm×5-20 mm×2-100 cm. Smaller micro-staves may also be created and used, such as micro-staves with dimensions of approximately 0.1 mm-5 mm×0.1 mm-5 mm×0.1 mm-5 mm;
b) Micro-staves are inspected for desired wood characteristics, sap wood is excluded. Inspection may include using blue and/or black/UV light to identify sap wood, for example light of wavelengths of 350 nm to 400 nm may be used to identify sap wood. Using blue and/or black/UV light increases the contrast between sap wood and heartwood and may allow, by itself and/or in combination with spectrometry, a fully automated inspection process to sort sap wood from heartwood and exclude sap wood;
c) Micro-staves are toasted at 330 and 550° F. for 10 min up to 100 hours. During toasting the weight and/or density change in the micro-staves may be measured to control toasting;
d) Micro-staves are charred with an infrared heater for a couple of seconds to multiple minutes;
e) A ratio of un-toasted, toasted-only, and toasted and charred micro-staves in any range or ratio (e.g., any ratio between toasted, un-toasted, and charred, as well as no charred, no un-toasted, or no toasted) may be used depending upon the targeted flavor. As one example, all charred micro-staves may be used with no toasted or un-toasted micro-staves used. As another example, all toasted micro-staves may be used with no charred or un-toasted micro-staves used. As a further example, all un-toasted micro-staves may be used with no toasted or charred micro-staves used. As yet another example, a percentage of charred and a percentage of toasted micro-staves may be used with no un-toasted micro-staves used. As yet another example, a percentage of charred and a percentage of un-toasted micro-staves may be used with no toasted micro-staves used. As yet another example, a percentage of un-toasted and a percentage of toasted micro-staves may be used with no charred micro-staves used. As a still further example, a percentage of charred, a percentage of toasted micro-staves, and a percentage of un-toasted micro-staves may be used. In addition to the charred, toasted, and/or un-toasted micro-staves, other wood products may be used, such as un-toasted wood material, wood powder (e.g., saw dust), etc. In some embodiments, other wood products, such as un-toasted wood material, wood powder (e.g., saw dust), etc., may be substituted for the untoasted micro-staves. Depending upon the recipe of the desired flavor a wood loading may be established with grams of wood to volume of spirits ratio of between 0.25% and 20%. When a concentrate is processed the wood to volume of spirits ratio would be increased by the concentration factor such that the range of ratios would be 0.5% to 200%. The micro-stave dimensions can be reduced below the 5-20 mm range, to such as 0.1 mm-5 mm, in order to increase the effectiveness of the micro-staves with higher concentrations of spirits. A powder of material with micro-stave controlled dimensions and toasting and charring can be formed with small dimensions in order to increase the surface area; and
f) Micro-staves and spirits and air are introduced into a vessel (e.g., a steel drum, etc.) which is kept at approximately atmospheric pressure and held at a temperature in the range of 120° F. to 170° F. with a stirred flow; with a spirits/air ratio of 25/75 to 75/25 such that the vessel is only ¼ filled up to ¾ filled; the process is executed for 1 to 5 days.

Various embodiments may include a method of conducting spirits maturing or refining including processing at more dilute concentrations than typical barrel-based aging. In typical aging a high alcohol concentration (e.g., as measured by alcohol by volume (ABV) is required to achieve the necessary interaction with the wooden barrel (e.g., typically 50% ABV and higher (bourbon usually around 60% ABV))). In the various embodiment processes, due to the acceleration granted by temperature, wood and atmosphere conditions maturing can result with lower alcohol concentrations than in typical barrel-based aging. Various embodiments may be suitable for extracting a significant amount of flavor from the wood with low alcohol concentrations, such as low as 0% alcohol (e.g., all water), less than 50% ABV, 20-30% ABV, etc. As an example, various embodiments may enable the production of a low alcohol whiskey, with 25% alcohol concentration. In traditional methods to get to lower amounts of alcohol one would have to barrel age at higher % ABV (e.g., 60% ABV) and then reduce the alcohol by adding water and/or removing the alcohol (e.g., by filtering or distillation). In contrast, the various embodiments may enable the production of lower alcohol concentrations (e.g., 25% ABV) without adding water and/or removing alcohol after maturing by the various embodiment processes.

Various embodiments may further include the steps of altering the water concentration, either before or after the maturing process, to achieve desired taste results.

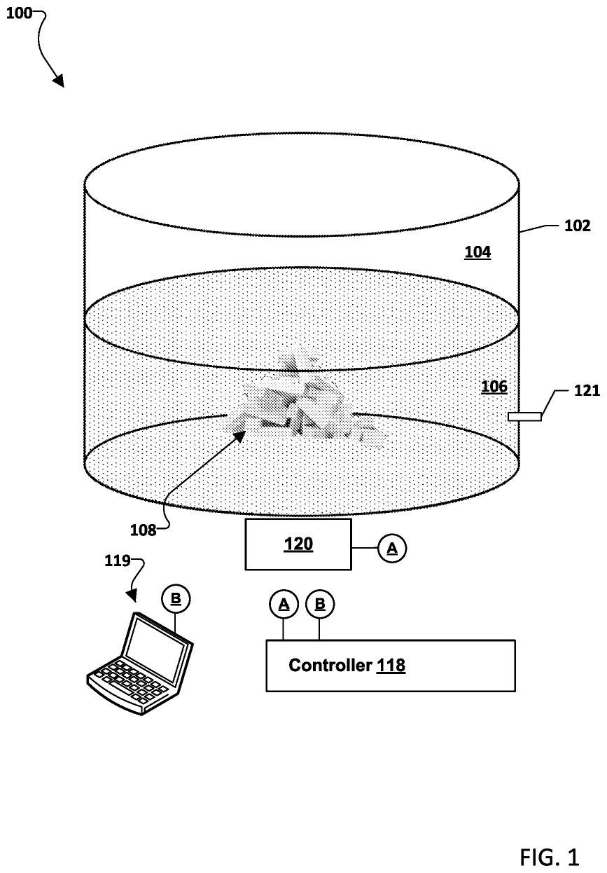

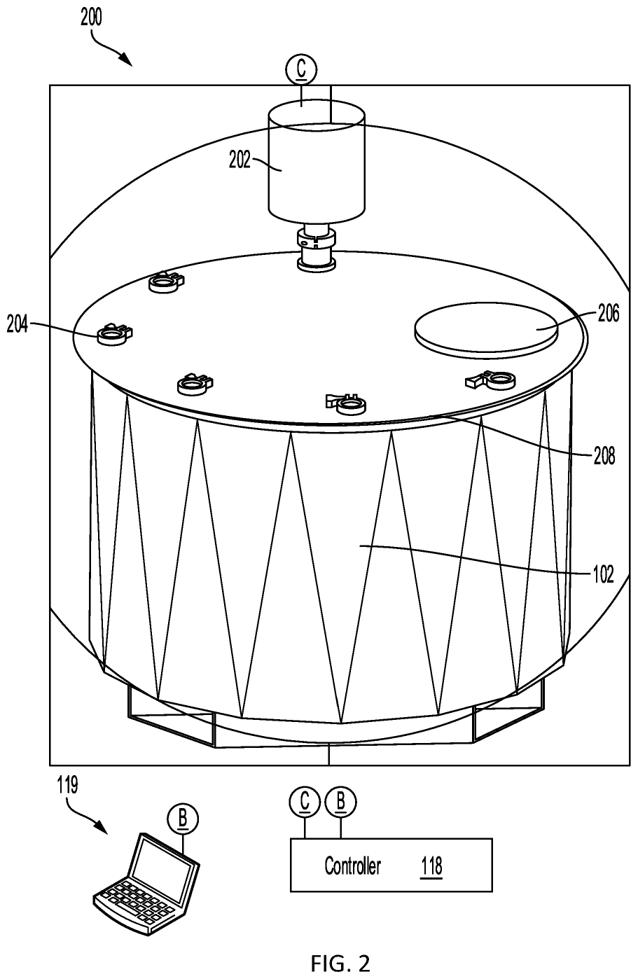

Various embodiments may include a structure for executing the embodiment method spirit maturation processes, the structure including a container which is filled with spirits to be processed; the structure configured such that an oxygen containing gas is presented to the spirits in a fixed ratio of oxygen to spirits; the structure configured such that micro-stave wood pieces in determined ratio of un-toasted, toasted and charred are presented to the spirits air mixture in a fixed ratio; the structure configured such that these are maintained at an elevated temperature such as 100-170° F. for a period of days; the structure configured such that a stirring of the mixture is completed; the structure configured such that samples of the mixture may be taken without opening the container; the structure configured such that leakage of vapors from the container is prevented via a hermetic seal. The structure may further include a condensation column with 100% reflux, check valve (heating), and/or vacuum relief valve (cooling). FIG. 1 illustrates an example of and description of such an embodiment structure 100 including a container 102. FIG. 2 illustrates another example of such an embodiment structure including a container. The structures of FIGS. 1 and 2 may be referred to as spirits processors. In a spirits processor, e.g., the structure of FIGS. 1 and 2, the various embodiment processes may be carried out. Not shown in FIG. 2 is a condensing column that may be included. The condensing column may be configured for 100% spirits recapture for venting along with vacuum break inlet check valve so as to provide for pressure control during both heating and cooling.

With reference to FIGS. 1 and 2, FIG. 1 illustrates a spirits processor 100 including a vessel 102 (or container) in which an oxygen containing gas 104, such as air, is held along with spirits 106 to be processed. Wood micro-staves 108 may be added in a ratio of toasted and charred micro-staves. In some embodiments, the micro-staves 108 may be floating free within the vessel 102. In some embodiments, the micro-staves 108 may be constrained within the vessel 102, such as in a mesh bag, perforated container, etc. The vessel 102 may hold the oxygen containing gas 104, such as air, etc., and spirits 106 to be matured in a ratio, such as 50% gas 104 and 50% spirits 106. The vessel 102 may be sealed. The vessel 102 may be heated to a selected temperature, such as to 150° F. For example, a heating system 120, such as heating system including heating elements, temperature sensors, etc., may be controlled to apply heat to the vessel 102. The heating system 120 may be any type heating system, such as part of the vessel 102 walls as a double wall jacketed heating system, an external electric heater, an internal electric heater, etc.

The ratios of wood micro-staves 108 to oxygen containing gas 104 to spirits 106 may be controlled. The mixture of wood micro-staves 108, oxygen containing gas 104, and spirits 106 in the vessel 102 may be stirred. A sampling port 121 may be provided in the vessel 102 to enable the progress of the spirit aging process to be determined by sampling the spirits 106 at one or more different times during the aging process.

The spirits processor 100 may include a controller 118 (e.g., a computer or dedicated control logic device or circuit) configured to monitor the conditions of the spirits processor 100 and/or to control the operations of the various elements of the spirits processor 100 to mature the spirits 106 according to various embodiments. The controller 118 may communicate, either directly or indirectly, with other components in the spirits processor 100 and/or with one or more remote control terminals 119. The communications may be via any type wired and/or wireless connections (e.g., labeled by letters A-B of FIG. 1). As a specific example, the controller 118 may control the heating system 120 to control the temperature within the vessel 102.

FIG. 2 illustrates a specific example of a spirits processor 200 including a vessel 102 (or container). The spirits processor 200 may be a specific example of the spirits processor 100 described with reference to FIG. 1. Various elements of the spirits processor 100 are not reproduced in FIG. 2 for ease of illustration, including the heating system 120 and the internal portions of the vessel 102, such as the spirits 106, oxygen containing gas 104, and wood micro-staves 108. The spirits processor 200 may include a stirring motor 202 that may connect to a stirring rod or agitator within the vessel 102. The controller 118 may communicate, either directly or indirectly, with the stirring motor 202. The communications may be via any type wired and/or wireless connections (e.g., labeled by letter C of FIG. 2). As a specific example, the controller 118 may control the stirring motor 202 to control the stirring of the mixture of the spirits 106, oxygen containing gas 104, and wood micro-staves 108 within the vessel 102. As one example, the vessel 102 may be a stainless steel vessel. The vessel 102 may be formed of a double wall construction.

The vessel 102 may include a vessel lid 208 that may be sealed to the vessel 102 so as to form a hermetic seal. The vessel lid 208 may include a plurality of plumbing ports 204. The plumbing ports 204 may provide access for various purposes and/or devices, such as a condenser, gas supply, temperature and other process parameter measurements and/or sensors, a pump connection, etc. The vessel lid 208 may include an access port 206. The access port 206 may enable the addition of micro-staves 108 and/or spirits 106 to the vessel 102 and may support cleaning of the vessel 102.

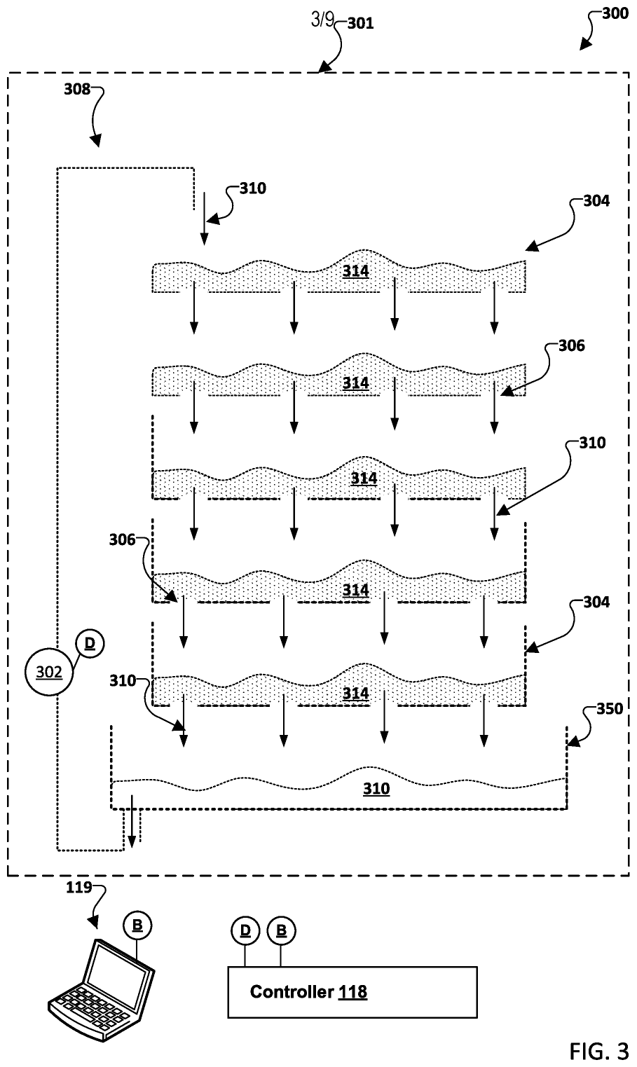

Various embodiments may include creating an in-line process wherein the process flow is made up a series of stages wherein the spirits fall, mix with air and drain to subsequent stages; at the bottom the spirits which have fallen through all of the stages are captured with a pump recirculating the spirits back to the top of the set of stages. FIG. 3 illustrates such an embodiment in-line process and spirits processor 300. With reference to FIGS. 1-3, the spirits processor 300 may be similar to spirits processors 100 and 200 described above. Spirits processor 300 may include a stacked cascade of buckets or containers 304. The containers 304 may be filled with spirits 310 (e.g., spirits 106) with an air interface (e.g., an interface to the oxygen containing gas 104). In some embodiments, the spirits processor 300 may include a vessel 301 encasing the containers 304. In some embodiments, the spirits processor 300 may be open to the air directly and not include a vessel 301. Drain holes 306 in the bottom of the containers 304 may allow the spirits 310 to rain down to the next container 304 and finally down to a bottom container or basin 350. This allows for a large air-spirits interface with gravity as the driving mixing mechanism. Each container 304 may include a bed of micro-staves 314 therein through which the spirits 310 filters as it drains from one container 304 to the next, A pump 302 and pipping system 308 coupled to the bottom basin 350 directs spirits 310 back to the top container 304 for recirculation. The pump 302 may connect to the controller 118 and may communicate, either directly or indirectly, with the controller 118. The communications may be via any type wired and/or wireless connections (e.g., labeled by letter D of FIG. 3). The process is continued until an endpoint is reached. While not shown in FIG. 3 for ease of illustration, one of ordinary skill will understand that spirits processor 300 may also include a heating system 120 and/or other components illustrated and discussed with reference to FIGS. 1 and/or 2.

In various embodiments, repeatable wood chips may be substituted for micro-staves in the various embodiment processes. In various embodiments, micro-staves may be wood pieces formed via various operations including chopping, laser cutting, small saw cutting, water jet cutting, electron beam cutting, etc. In various embodiments, using thermal cutting technologies to form the micro-staves may replace the charring step(s).

In various embodiments, toasting of micro-staves may be performed by an oven batch process. In various embodiments, toasting of micro-staves may be performed by a belt furnace continuous process. In various embodiments, micro-staves may be toasted in a rotary tumbler, in either batch or continuous processes.

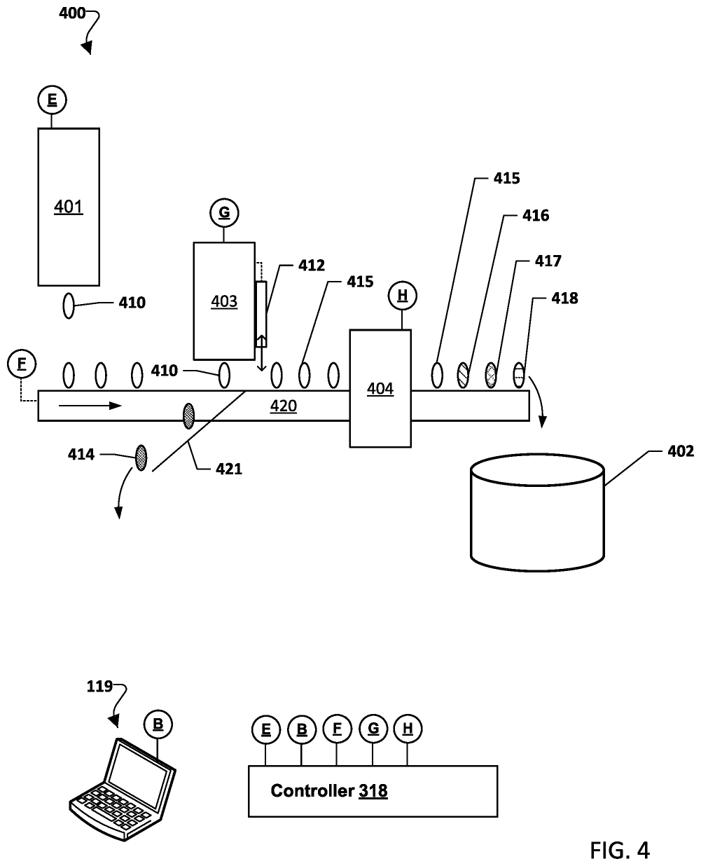

FIG. 4 illustrates an example system in which micro-staves 410 are inspected and optionally toasted and/or charred prior to insertion into a spirits processor 402. With reference to FIGS. 1-4, the spirits processor 402 may be a spirits processor as described herein, such as spirits processor 100, 200, 300, etc. The system 400 may include various components, such as a micro-stave delivery system 401, a belt 420, an inspection system 403, a furnace 404, and the spirits processor 402. The micro-stave delivery system 401, the belt 420, the inspection system 403, the furnace 404, and the spirits processor 402 may connect to the controller 118 and may communicate, either directly or indirectly, with the controller 118. The communications may be via any type wired and/or wireless connections (e.g., labeled by letters E-H of FIG. 4). The controller 118 may control the operations of the micro-stave delivery system 401, the belt 420, the inspection system 403, the furnace 404, and the spirits processor 402 as discussed above with reference to FIGS. 1-3 and further below.

The micro-stave delivery system 401 may be controlled by the controller 118 to provide micro-staves onto a belt 420 that may move the micro-staves toward an inspection system 403. The belt 420 speed may be controlled by the controller 118. The inspection system 403 may be controlled by the controller 118 to sort desired micro-staves 415 from undesired micro-staves 414. For example, micro-staves 414 formed from sap wood may be undesirable and micro-staves 415 formed from heartwood may be desirable. The inspection system 403 may allow the heartwood micro-staves 415 to pass and exclude the sap wood micro-staves 414. The inspection system 403 may use cameras and/or spectrometers to sort the micro-staves 410. The inspection system 403 may use blue and/or black/UV light to increases the contrast between sap wood and heartwood. The inspection system 403 may use the blue and/or black/UV light on its own, and/or in combination with spectrometry, to select desired micro-staves 415. For example, upon detecting that a provided micro-stave 410 is an undesired micro-stave 414, the inspection system 412 may activate a moving arm 412 to divert the undesired micro-stave 414 down a discard shoot 421 and off the belt 420.

The desired micro-staves 415 may proceed to the furnace 404. The controller 118 may control the furnace 404 such that the desired micro-staves 415 may be charred by the furnace 404 to form charred micro-staves 418 toasted by the furnace 404 to form toasted micro-staves 417, charred and toasted by the furnace 404 to form charred and toasted micro-staves 416, and/or may be left un-charred and un-toasted by the furnace 404 (thereby staying as originally selected as desired micro-staves 415). The various types of micro-staves, 415, 416, 417, and/or 418 may be provided from the belt 420 to the spirits processor 402 in various combinations and/or ratios.

In various embodiments, the maturing process of the spirits may be controlled based on an oxygen portion in ratio to the spirits volume, wherein the nitrogen portion is ignored. In various embodiments, the oxygen that is present during maturation in the vessel/reactor may be controlled. Controlling the maturing process of the spirits based on an oxygen portion in ratio to the spirits volume may mean the ratio in volume between the spirit and the “headspace” in the vessel/reactor is controlled. For example, 75% may mean the vessel is filled ¼ with spirit and with air. The oxygen in the air is important for oxidation reactions that are happening. Those reactions may be controlled by controlling the oxygen available. In traditional barrel aging, the oxygen level is left to mother nature depending on things like temperature of the rick house, how tight the barrel/wood is, etc. In various embodiments, the ratio of the volume of spirits to the volume of oxygen (e.g., headspace volume) in the vessel/reactor may be controlled.

In some embodiments, controlling the oxygen that is present during maturation may include using an active oxygenation process in which oxygen is introduced into the vessel/reactor in a controlled manner during e entire maturation process and/or at certain points in the maturation process. For example, the oxygen may be injected into the spirit using a porous ceramic or stainless steel stone/foam in a manner similar to that of microoxygenation of wine.

In various embodiments, lab air of pure N₂/O₂ or pure Ar/O₂ or pure O₂ or mixtures of N₂, O₂ and Argon or other inert gases, instead of ambient air, may be used in the toasting and/or charring processes.

In various embodiments, lab air of pure N₂/O₂ or pure Ar/O₂ or pure O₂ or mixtures of N₂, O₂ and Argon or other inert gases, instead of ambient air, may be used in spirits processor for the air portion.

In various embodiments, the humidity of the air used in either of the toasting, charring or liquid processing steps may be fixed. In one such alternative embodiment, the air may be fully humidified to saturated conditions. In another embodiment, the air may be fully dried with all ambient air moisture removed. In a third embodiment, a targeted dew point may be achieved and controlled for the input air.

Various embodiments may include creating a stirring effect in the spirits maturing structure (e.g., a spirits processor, such as a spirits processor of FIGS. 1-3), such as in the vessel (e.g., container)). The stirring effect may be created by pressure, such as pumping flows through the process vessel either directly or with a jet pump. The stirring effect may be created by driving flows using an air driven venturi or other means of stirring or agitation, such as using ultrasonic stirring devices.

Various embodiments may include applying various process described herein with wood barrels. Various embodiments may include toasting, charring, half-filing, heating and stirring a barrel of spirits. Various embodiments may include the following steps:
a) Barrel staves are inspected, and sap wood is rejected;
b) A certain ratio, such as 50% of the staves, are left un-toasted and/or are toasted; the remainder of the staves are toasted and then charred;
c) The barrel is filled 75% full of spirits; 25% full of air (such as ambient air or lab air);
d) The barrel is sealed with an outer, jacket which has either zero or a controller permeability of spirits and air;
e) The barrel is held at 120-170° F. for a period such as 1-20 days; and
f) The barrel is agitated via means such as rotation, vibration, shaking.

Various embodiments may include creating long tubes or gutters or spiral channels of wooden elements which have been toasted or charred in a controlled fashion as per the various processes described herein; and then recirculating spirits with a 75/25 spirits/air ratio at a temperature such as 120-170° F. for 1-20 days.

Various embodiments may include scanning staves or barrels to be used for spirits or wine making with to detect areas of sap wood to allow for rejection of those barrels or replacement of those portions of the barrels to prevent creating negative taste results from maturation. Inspection may include using blue and/or black/UV light to identify sap wood, for example light of wavelengths of 350 nm to 400 nm may be used to identify sap wood. Using blue and/or black/UV light increases the contrast between sap wood and heartwood and may allow in combination with spectrometry a fully automated inspection process to sort sap wood from heartwood and exclude sap wood.

Various embodiments may include a structure and method of complete or partial distillation as part of the various embodiments processes described herein to remove unwanted spirits items such as: a) Water, which may be removed to increase the proof of spirits; and/or b) Unwanted bad-taste elements, such as methanol, acetone and others which are known to cause head-aches for customers.

Various embodiments may include the method of improving or adjusting fruitiness, floral-amount by pre-soaking micro-staves in a flavoring liquid, such as wine, or by direct addition of a liquid, such wine, at such as 500 ppm. Various embodiments may include pressure treating the wooden micro-staves with these compounds (e.g., flavoring liquid, such as wine) to increase the degree of pre-soaking.

Various embodiments may include the use of charcoal in addition to or instead of micro-staves of charred and toasted wood as a means to absorb compounds from the input spirits or intermediary compounds which may come from the refining process.

Various embodiments may include the use of catalysts to trigger and accelerate favorable reactions for taste and aroma.

Various embodiments may include methods wherein the ratio of untoasted, toasted and charred micro-staves can be tailored to achieve a discrete repeatable flavor profile.

Various embodiments may include methods wherein toasting temperature and time for micro-staves can be tailored to achieve a discrete repeatable flavor profile.

Various embodiments may include methods wherein toasting temperature and time for micro-staves, as well as the ratio of toasted to charred micro-staves, can be tailored to achieve a discrete repeatable flavor profile.

Various embodiments may include methods wherein controlling the charred surface area of micro-staves can be tailored to achieve a discrete repeatable flavor profile.

Various embodiments may include methods using characterized metrics to monitor either design experiments or production processes and by forming correlations with taste factors eliminate the human taster from the evaluation process; and further allow for process control with the metrics of concern.

Various embodiments may include methods of characterizing spirits using metrics which correlate to taste factors. In various embodiments, a transfer function these spirits may be characterized as to their taste characteristics—and then a desired maturation process may be applied.

In various embodiments, metrics which may be used in the characterizations and controls may include one or more of: pH of the spirits; color measurement of the spirits as measured with a spectrometer; gas chromatograph mass spectrometry to characterize the spirits for presence of key compounds; the UV spectrum adsorption of the spirits; the turbidity measurement of the spirits; dissolved nitrate, nitrite, sulfate, sulfite, phosphate, phosphite concentration; measurement of specific acids; measurement of methanol or acetone; conductivity or resistivity measurements; and/or measurement of proof or water content.

Various embodiments may include a method of conducting the following steps on a batch of input spirits to create a desired output spirits products:
a) Characterizing the input spirits with lab and/or human taste assessment;
b) Creating a target result of taste parameters;
c) Creating a predicted result of the output using transfer function relationships of input product to execution of the various embodiment processes described herein;
d) if desired conducting a refining Design-of-Experiments step wherein small portions of input batch are processed using a matrix of process parameters about the predicted settings per the transfer function. Then, with a micro-scaled reactor which executes the various embodiment processes in very small scale, an array of outputs are created. These are then characterized by lab or human methods. And, the transfer function is updated based on these refining results; and
e) When the predicted output from transfer function and/or design of experiments is to target, then the batch is processed in accordance with the required process parameters according to one or more various embodiment processes described herein.

In a preferred embodiment, the process parameters which are modulated in the various embodiment spirit maturing processes include, pre-soaking of micro-staves in water or other liquids, altering the toasting or charring recipe of the micro-staves, altering the untoasted, toasted, and charred micro-stave ratio in the spirit maturing structure (e.g., a spirits processor, such as a spirits processors of FIGS. 1-4), altering the oxygen, temperature, pH, color or other end-point selected for the spirit maturing process completion.

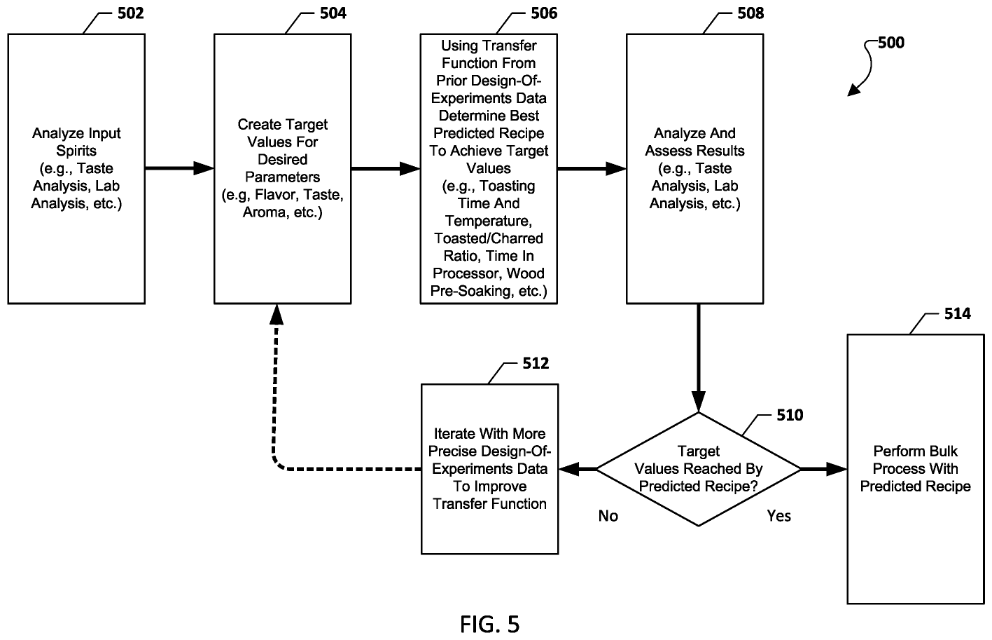

FIG. 5 illustrates a method 500 for modifying the taste of input spirits based on a transfer function. FIG. 5 depicts the process steps according to various embodiments for modifying the taste of input spirits based on a transfer function which is created by design of experiments (DOE). The operations of method 500 may be performed, at least in part, using the systems and devices described above (e.g., 100, 200, 300, and/or 400). The operations of method 500 may provide a process for parameter adjustment of spirits, such as flavor, color, and/or aroma.

In a first step 502, input spirits may be analyzed. Analyzing the input spirits may include performing a taste analysis, lab analysis, or other type analysis.

In a next step 504, one or more target values for desired parameters may be created. As examples, one or more target values may be target values for desired flavor, taste, and/or aroma parameters.

In a next step 506, a transfer function from prior design-of-experiments (DOE) data may be used to determine a best predicted recipe to achieve the target values of step 504. As examples, one or more of toasting time and temperature of micro-staves, a toasted to charred micro-stave ratio, time in a spirits processor, wood pre-soaking levels, and/or other controllable aspects of spirits processing may be inputs to the transfer function that are adjusted to determine a best predicted recipe to achieve the target values of step 504.

In step 508, the spirits may again be analyzed and the results of the predicted recipe of step 506 may be assessed. Analyzing the input spirits may include performing a taste analysis, lab analysis, or other type analysis. Assessing the results of the predicted recipe of step 506 may include characterizing values associated with flavor, taste, and/or aroma parameters of the spirits as resulted from the performance of step 506.

In step 510, it may be determined whether the target values were achieved by the predicted recipe of step 506. For example, values associated with flavor, taste, and/or aroma parameters of the spirits as resulted from the performance of step 506 may be compared to the target value created in step 504 to determine whether those values match the target values to determine whether the target values were achieved. A match, or near match within a threshold, may indicate the target values were reached. A non-match, or non-match outside a threshold, may indicate the target values were not reached. In response to determining the target values were not achieved by the predicted recipe of step 506, in step 512 the process may be iterated with more precise design-of-experiments (DOE) data to improve the transfer function. The steps 504, 506, 508, 510, and 512 may be continually iteratively performed until the target values are reached by the predicted recipe.

Upon the target values being reached, in step 514 bulk processing of spirits may be performed with the predicted recipe. In this manner, the hulk processed spirits may have be created by the predicted recipe and have the desired flavor, taste, and/or aroma parameters.

The method 500 illustrated in FIG. 5 may also have business model application. The method 500 may enable product to be made directly from a model. The method 500 may enable sampled to be made from a model, a test to occur, and fine tuning of the model to occur before then making the product from the finetuned model. The method 500 may enable spirits to be modified to be assessed, then a model to be assessed and/or finetuned, and the model (whether as selected or finetuned.) to be used to then make the product.

Various embodiments may include blending, refining, finishing of spirits to improve the taste of a less good batch of spirits.

Various embodiments may include inserting a fingerprinting compound into the spirits processed via the various embodiment processes to prevent counterfeiting.

Various embodiments may include process control schemes for the spirit maturing process. Process control schemes may include in-process sampling during to determine if the desired end-point has been reached. Process control schemes may include measuring parameters such as color of the spirits, oxygen content of the spirits, redox potential or pH of the spirits to determine indicator of end-point.

Various embodiments may include the use of taste assessment parameters in this list for creating transfer function and design-of-experiment aspects of the spirit maturing process for parameter adjustment. Taste parameters (or tastes assessment parameters) may include one or more of: Appearance; Palate (Mouth feel); Wood; Grain; Sweet; Spice; Vanilla; Fruity notes (e.g., such as apple or banana); and/or Floral notes (such as rose).

Various embodiments may include using a micro-scaled reactor to execute the various embodiments processes on lab-scaled samples and then processing batches in large-scale processor (e.g., a spirits processor, such as a spirits processor of FIGS. 1-4) to create the same result at large scale.

Various embodiments may include using feed-forward aspects of changing alcohol concentration. Water content may be changed before or after the refining process to have an impact on flavor or color parameters. This is contrary to the typical barrel process where concentrations of alcohol are typically as high as possible with dilution afterward. With the various embodiments processes the maturing or refining process is possible at lower proof levels than with barrels because of the elevated temperature and other accelerating factors such as specific micro-stave selection. (The temperature effect increases the extraction and allows for the solvent to be effective at a lower proof.) Proof as used herein means twice the ABV (i.e., 2×ABV). Various embodiments may be suitable for extracting a significant amount of flavor from the wood with low alcohol concentrations, such as low as 0 proof (e.g., all water), less than 100 proof, 40-60 proof, etc. As an example, various embodiments may enable the production of a low alcohol 50 proof whiskey. The various embodiments may enable maturing and refining processes with low proof levels, such as low as zero proof, less than 100 proof, 40-60 proof, etc. Lower alcohol spirits enabled by the various embodiments may be particularly advantageous as more and more low alcohol alternatives are being requested by customers.

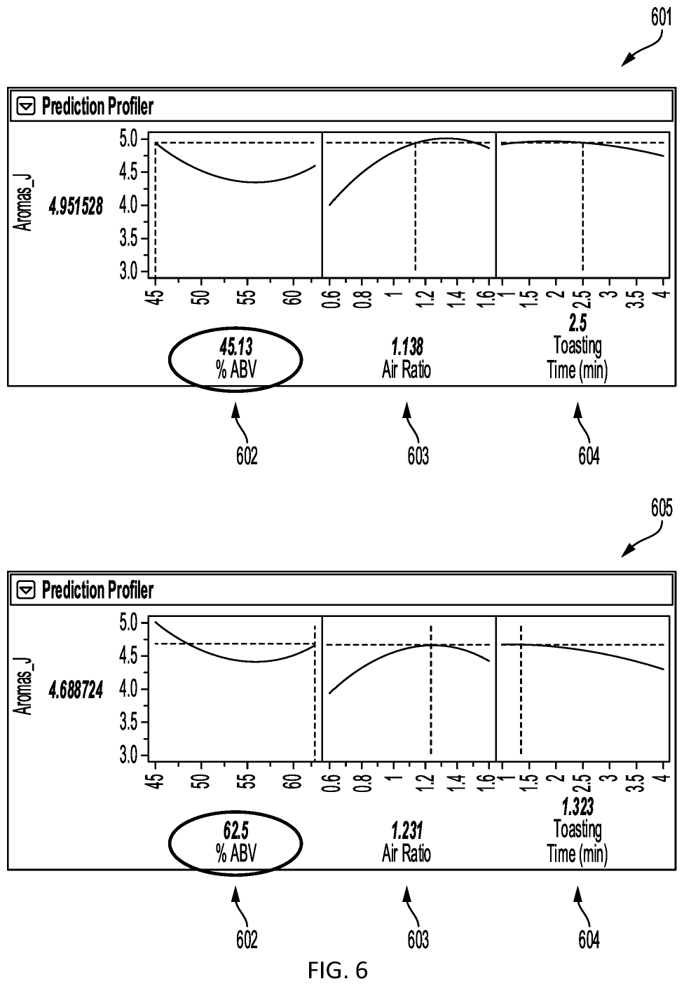

On specific example implementation of the embodiment feedforward operations may be “aroma” prediction and control using feedforward processes. FIG. 6 illustrates example aroma prediction profiles 601 and 605 according to various embodiments. The prediction profiles 601 and 605 may be graphical user interface elements displaying to a user, such as a user of a remote control terminal (e.g., 119, etc.), the predicted aroma. The prediction profiles 601 and 605 may include graphical indications of ABV 602, air ratio 603, and toasting time 604. The parameter “aroma” is correlated with better taste results in blind testing. Following this, process parameters are varied in a designed experiment to evaluate the results with respect to the parameter “aroma”. The following parameters are evaluated with two types of spirits. In a first spirits type (in the prediction profile 601) an ideal ABY of 45% is found. An ideal air ratio of roughly 1.1 is found and an ideal toasting time of 2.5 hours is found. These results achieve an “aroma” taste result maximum. In a second spirits type, maximum “aroma” is achieved with different % ABV, air ratio and toasting time of 62%, 1.2 and 1.3 hours as shown in the prediction profile 605.

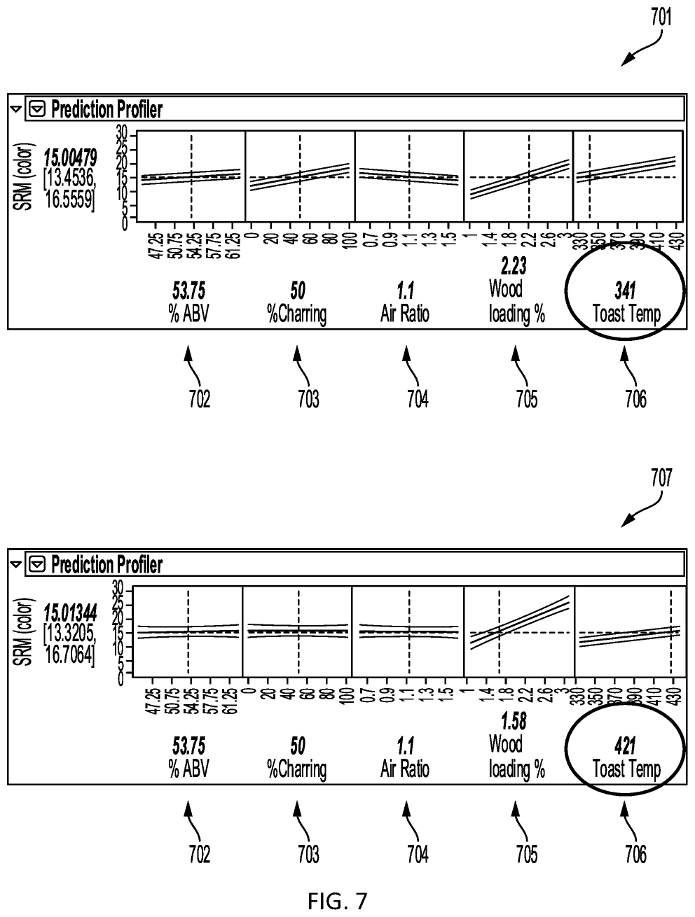

Another specific example implementation of the embodiment feedforward operations may be the parameter “color” or “SRM” is found to be ideal when at the value of 15. FIG. 7 illustrates example “color” or “SRM” prediction profiles 701 and 707 according to various embodiments. The prediction profiles 701 and 707 may be graphical user interface elements displaying to a user, such as a user of a remote control terminal (e.g., 119, etc.), the predicted “color” or “SRM”. The prediction profiles 701 and 707 may include graphical indications of percentage ABV 702, percent charring 703, air ratio 704, wood loading 705, and toasting temperature 706. Five process parameters are evaluated with response to “color” and a result to achieve 15 if found for two different types of spirits, one of prediction profile 701 and one of prediction provide 707. Values for percentage ABV 702, percent charring 703, air ratio 704, wood loading 705, and toasting temperature 706 are all found to be significant with optimized values for each being selected. The profiles 701, 707 in FIG. 7 show how the five parameters percentage ABV 702, percent charring 703, air ratio 704, wood loading 705, and toasting temperature 706 impact SRM. In this manner, changes in toasting temperature 706 and resulting wood loading 705 to achieve the desired SRM of 15 can be visualized.

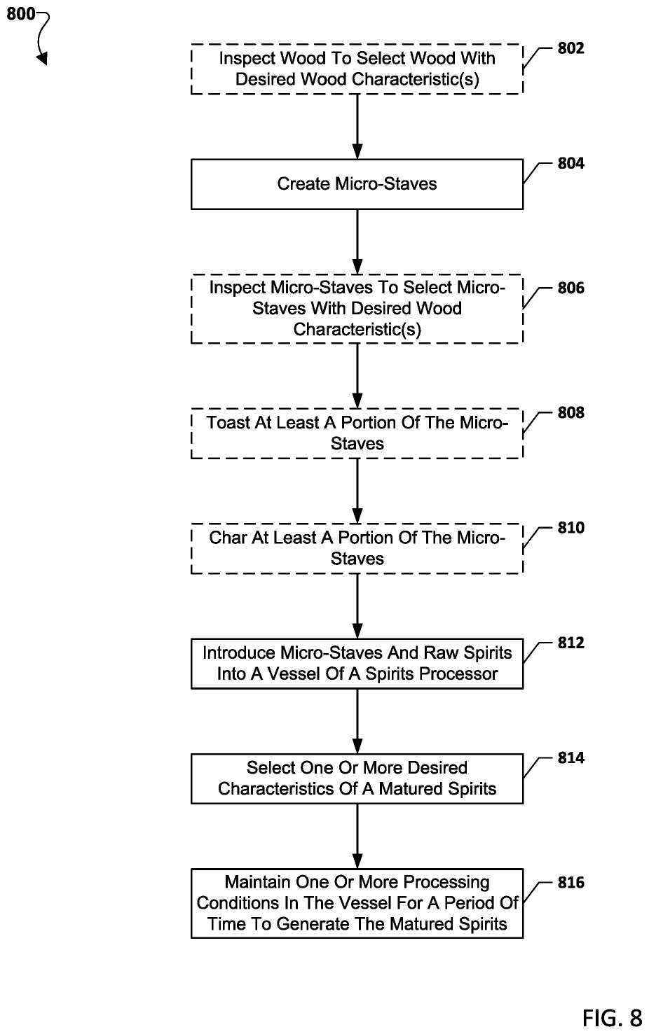

FIG. 8 illustrates a method 800 for creating matured spirits from raw spirits in accordance with various embodiments. With reference to FIGS. 1-8, in various embodiments, the operations of method 800 may be performed, at least in part, using the systems and devices described above (e.g., 100, 200, 300, and/or 400). As an example, operations of method 800 may be implemented at least in part by the controller 118 and/or remote control terminal 119.

In optional block 802, wood may be inspected to select wood with one or more desired wood characteristics. For example, wood may be inspected to select wood that is heartwood and to exclude wood that is sap wood. As another example, wood may be inspected to select a desired type of wood, such as oak and exclude other types of wood. Inspection may be performed with a light, such as a blue, black, UV light, etc., and/or with spectrometry. Block 802 may be optional as wood may be formed into micro-staves prior to inspection and inspection of the source wood for micro-staves may be skipped.

In block 804, micro-staves may be created. Micro-staves may be created using various operations including chopping, laser cutting, small saw cutting, water jet cutting, electron beam cutting, thermal cutting, etc. Micro-staves may be created with dimensions of approximately 5-20 mm×5-20 mm×2-100 cm. Smaller micro-staves may also be created, such as micro-staves with dimensions of approximately 0.05-5 min×0.05-5 mm×0.05-5 min.

In block 806, micro-stave may be inspected to select micro-staves with desired wood characteristics. For example, micro-staves may be inspected to select micro-staves made from heartwood and to exclude micro-staves made from sap wood. As another example, micro-staves may be inspected to select a desired type of wood micro-stave, such as oak and exclude other types of wood micro-staves. Inspection may be performed with a light, such as a blue, black, UV light, etc., and/or with spectrometry. Block 806 may be optional as the wood may have been inspected prior to creation of the micro-staves. Alternatively, inspection in block 806 may be a further inspection in addition to at least the inspection of optional block 802.

In optional block 808, at least a portion of the micro-staves may be toasted. A toasting temperature and time for micro-staves may be tailored to achieve a flavor profile of the matured spirits. As an example, micro-staves may be toasted at 330 and 550° F. for 10 min up to 100 hours. During toasting the weight and/or density change in the micro-staves may be measured to control toasting.

In optional block 810, at least a portion of the micro-staves may be charred. A charred surface area of micro-staves may be tailored to achieve a flavor profile of the matured spirits. As an example, micro-staves may be charred with an infrared heater for a couple of seconds to multiple minutes.

Blocks 808 and 810 may be optional, as not all micro-staves may be toasted and/or charred. The micro-staves in the method 800 may be a group of micro-staves including toasted micro-staves, un-toasted micro-staves, and/or charred micro-staves. A ratio of un-toasted, toasted-only, and toasted and charred micro-staves in any range or ratio (e.g., any ratio between toasted, un-toasted, and charred, as well as no charred, no un-toasted, or no toasted) may be used depending upon the targeted flavor. As one example, all charred micro-staves may be used with no toasted or un-toasted micro-staves used. As another example, all toasted micro-staves may be used with no charred or un-toasted micro-staves used. As a further example, all un-toasted micro-staves may be used with no toasted or charred micro-staves used. As yet another example, a percentage of charred and a percentage of toasted micro-staves may be used with no un-toasted micro-staves used. As yet another example, a percentage of charred and a percentage of un-toasted micro-staves may be used with no toasted micro-staves used. As yet another example, a percentage of un-toasted and a percentage of toasted micro-staves may be used with no charred micro-staves used. As a still further example, a percentage of charred, a percentage of toasted micro-staves, and a percentage of un-toasted micro-staves may be used. In this manner, a ratio of untoasted, toasted, and charred micro-staves may be tailored to achieve a flavor profile of the matured spirits. Additionally, a toasting temperature and time for micro-staves and a ratio of toasted, un-toasted, and charred micro-staves may be tailored to achieve a flavor profile of the matured spirits.

In block 812, the group of micro-staves and raw spirits may be introduced into a vessel (e.g., 102, 301, etc.) of a spirits processor (e.g., 100, 200, 300, 402, etc.).

In block 814, one or more desired characteristics of a matured spirits may be selected. As examples, the one or more desired characteristics may include one or more of alcohol concentration, aroma, flavor, and color.

In block 816, one or more processing conditions may be maintained in the vessel (e.g., 102, 301, etc.) for a period of time to generate the matured spirits. In various embodiments, the period of time may be from 1 hour to 20 days. In various embodiments, the one or more processing conditions may include temperature, air content, pressure, and/or oxygen content. In various embodiments, maintaining the one or more processing conditions in the vessel for a period of time to generate matured spirits may be controlled using characterized metrics. The characterized metrics may be correlated to taste factors of the matured spirits. The characterized metrics may include one or more of: pH of the spirits; color measurement of the spirits as measured with a spectrometer; gas chromatograph mass spectrometry to characterize the spirits for presence of key compounds; the UV spectrum adsorption of the spirits; the turbidity measurement of the spirits; dissolved nitrate, nitrite, sulfate, sulfite, phosphate, phosphite concentration; measurement of specific acids; measurement of methanol or acetone; conductivity or resistivity measurements; and/or measurement of proof or water content. As one specific example, maintaining one or more processing conditions may include keeping a vessel (e.g., 102, 301, etc.) at approximately atmospheric pressure and holding the vessel at a temperature in the range of 120° F. to 170° F. with a stirred flow, with a spirits/air ratio of 25/75 to 75/25 such that the vessel is only ¼ filled up to ¾ filled, and the process is executed for 1 to 5 days.

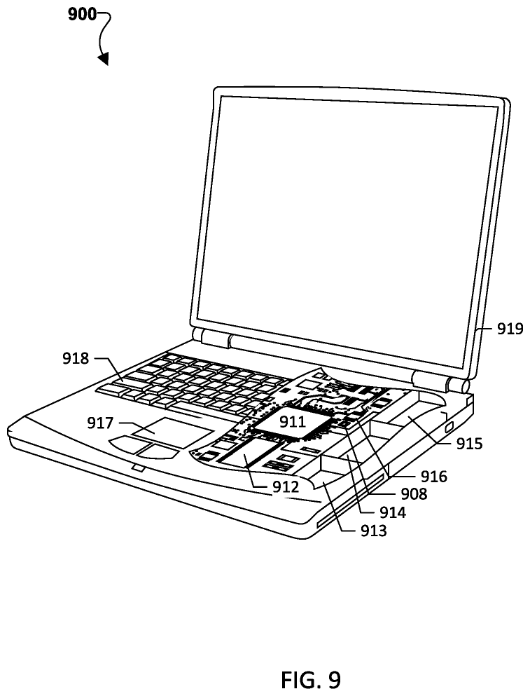

The various embodiment methods may be performed partially or completely on a variety of computing devices, such as a laptop computer 900 illustrated in FIG. 9. Laptop computer 900 may be one example of a remote control terminal (e.g., 119, etc.) suitable for use in various embodiments. Many laptop computers include a touchpad touch surface 917 that serves as the computer's pointing device, and thus may receive drag, scroll, and flick gestures similar to those implemented on mobile computing devices equipped with a touch screen display and described above. A laptop computer 900 will typically include a processor 911 coupled to volatile memory 912 and a large capacity nonvolatile memory, such as a disk drive 913 of Flash memory. Additionally, the computer 900 may have one or more antennas 908 for sending and receiving electromagnetic radiation that may be connected to a wireless data link and/or cellular telephone transceiver 916 coupled to the processor 911. The computer 900 may also include a floppy disc drive 914 and a compact disc (CD) drive 915 coupled to the processor 911. In a notebook configuration, the computer housing includes the touchpad 917, the keyboard 918, and the display 919 all coupled to the processor 911. Other configurations of the mobile computing device may include a computer mouse or trackball coupled to the processor (e.g., via a USB input) as are well known, which may also be used in conjunction with the various embodiments.

Implementation examples are described in the following paragraphs. While some of the following implementation examples are described in terms of example methods, further example implementations may include: the example methods discussed in the following paragraphs implemented by a spirits processor (e.g., spirits processor 100, 200, 300, etc.) comprising a vessel, the spirits processor configured to perform the operations of the example methods. Example 1. A method for creating matured spirits from raw spirits, comprising: introducing a group of micro-staves and raw spirits into a vessel of a spirits processor; maintaining one or more processing conditions in the vessel for a period of time to generate matured spirits. Example 2. The method of Example 1, further comprising: creating micro-staves; inspecting the wood micro-staves are made of as well as the micro-staves to select micro-staves with a desired wood characteristic; toasting a portion of the micro-staves having a desired wood characteristic; and charring at least a portion of the micro-staves having a desired wood characteristic, wherein the group of micro-staves includes toasted micro-staves, un-toasted micro-staves, and/or charred micro-staves. Example 3. The method of Example 2, wherein the micro-staves are smaller than 20 mm×20 mm×100 cm. Example 4. The method of Example 2, wherein the micro-staves are 5 mm×5 mm×2 cm. Example 5. The method of Example 2, wherein the micro-staves are 0.05-5 mm×0.05-5 mm×0.05-5 mm Example 6. The method of any of Examples 1-5, wherein the period of time is from 1 hour to 20 days. Example 7. The method of any of Examples 1-6, wherein the one or more processing conditions include temperature, air content, pressure, or oxygen content. Example 8. The method of Example 7, wherein a ratio of untoasted, toasted, and charred micro-staves is tailored to achieve a flavor profile of the matured spirits. Example 9. The method of any of Examples 7-8, wherein a toasting temperature and time for micro-staves is tailored to achieve a flavor profile of the matured spirits. Example 10. The method of Example 9, wherein toasting temperature and time for micro-staves and a ratio of toasted, un-toasted, and charred micro-staves is tailored to achieve a flavor profile of the matured spirits. Example 11. The method of any of Examples 1-10, wherein a charred surface area of micro-staves is tailored to achieve a flavor profile of the matured spirits. Example 12. The method of any of Examples 1-11, wherein maintaining one or more processing conditions in the vessel for a period of time to generate matured spirits is controlled using characterized metrics. Example 13. The method of Example 12, wherein the characterized metrics are correlated to taste factors of the matured spirits. Example 14. The method of any of Examples 1-13, wherein the characterized metrics include one or more of: pH of the spirits; color measurement of the spirits as measured with a spectrometer; gas chromatograph mass spectrometry to characterize the spirits for presence of key compounds; the UV spectrum adsorption of the spirits; the turbidity measurement of the spirits; dissolved nitrate, nitrite, sulfate, sulfite, phosphate, phosphite concentration; measurement of specific acids; measurement of methanol or acetone; conductivity or resistivity measurements; and/or measurement of proof or water content. Example 15. The method of any of Examples 2-14, wherein the inspection is performed with a blue, black, or UV light. Example 16. The method of any of Examples 2-15, further comprising selecting one or more desired characteristics of the matured spirits, wherein the processing conditions in the vessel are controlled by one or more feed-forward processes to generate the mature spirits having the selected one or more desired characteristics. Example 17. The method of Example 16, wherein the one or more desired characteristics include one or more of alcohol concentration, aroma, flavor, and color.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect.

In an embodiment, the functions of one or more controllers of a spirits processor may be implemented in software, hardware, firmware, on any combination of the foregoing. In an embodiment, the hardware may include circuitry designed for implementing the specific functions of the one or more controllers of a spirits processor. In an embodiment, the hardware may include a programmable processing device configured with instructions to implement the functions of the one or more controllers of a spirits processor.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

One or more block/flow diagrams have been used to describe exemplary embodiments. The use of block/flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

Control elements may be implemented using computing devices (such as computer) comprising processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, hut, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

1. A method for creating matured spirits from raw spirits, comprising:
introducing a group of micro-staves and raw spirits into a vessel of a spirits processor;
maintaining one or more processing conditions in the vessel for a period of time to generate matured spirits.

2. The method of claim 1, further comprising:
creating micro-staves;
inspecting wood the micro-staves are made of, and/or the micro-staves, to select micro-staves with a desired wood characteristic;
toasting a portion of the micro-staves having a desired wood characteristic; and
charring at least a portion of the micro-staves having a desired wood characteristic,
wherein the group of micro-staves includes toasted micro-staves, un-toasted micro-staves, and/or charred micro-staves.

3. The method of claim 1, wherein the micro-staves are smaller than 20 mm×20 mm×100 cm.

4. The method of claim 1, wherein the micro-staves are 5 mm×5 mm×2 cm.

5. The method of claim 1, wherein the micro-staves are 0.05-5 mm×0.05-5 mm×0.05-5 mm.

6. The method of any of claim 1, wherein the period of time is from 1 hour to 20 days.

7. The method of claim 1, wherein the one or more processing conditions include temperature, air content, pressure, or oxygen content.

8. The method of claim 7, wherein the group of micro-staves includes toasted micro-staves, un-toasted micro-staves, and/or charred micro-staves and a ratio of untoasted, toasted, and charred micro-staves is tailored to achieve a flavor profile of the matured spirits.

9. The method of claim 7, wherein a toasting temperature and time for micro-staves is tailored to achieve a flavor profile of the matured spirits.

10. The method of claim 7, wherein the group of micro-staves includes toasted micro-staves, un-toasted micro-staves, and/or charred micro-staves and toasting temperature and time for micro-staves and a ratio of toasted, un-toasted, and charred micro-staves is tailored to achieve a flavor profile of the matured spirits.

11. The method of claim 7, wherein a charred surface area of micro-staves is tailored to achieve a flavor profile of the matured spirits.

12. The method of claim 1, wherein maintaining one or more processing conditions in the vessel for a period of time to generate matured spirits is controlled using characterized metrics.

13. The method of claim 12, wherein the characterized metrics are correlated to taste factors of the matured spirits.

14. The method of claim 13, wherein the characterized metrics include one or more of: pH of the spirits; color measurement of the spirits as measured with a spectrometer; gas chromatograph mass spectrometry to characterize the spirits for presence of key compounds; the UV spectrum adsorption of the spirits; the turbidity measurement of the spirits; dissolved nitrate, nitrite, sulfate, sulfite, phosphate, phosphite concentration; measurement of specific acids; measurement of methanol or acetone; conductivity or resistivity measurements; and/or measurement of proof or water content.

15. The method of claim 2, wherein the inspection is performed with a blue, black, or UV light.

16. The method of claim 2, further comprising selecting one or more desired characteristics of the matured spirits,
wherein the processing conditions in the vessel are controlled by one or more feed-forward processes to generate the mature spirits having the selected one or more desired characteristics.

17. The method of claim 16, wherein the one or more desired characteristics include one or more of alcohol concentration, aroma, flavor, and color.

18. A spirits processor comprising a vessel, the spirits processor configured to perform operations of claim 1.
